(19) United States
(12) Patent Application Publication
(10) Pub. No.: US 2009/0189049 A1
(43) Pub. Date: Jul. 30, 2009

(54) Rotary Display Stand

(76) Inventor: Chin-Sung Chang, Tucheng City (TW)

Correspondence Address: DLA PIPER LLP (US ), 2000 UNIVERSITY AVENUE, EAST PALO ALTO, CA, 94303-2248, US

(21) Appl. No.: 12/182,114

(22) Filed: Jul. 29, 2008

(30) Foreign Application Priority Data
Jan. 25, 2008 (TW) 097102855

(51) Int. Cl. F16M 13/00

(52) U.S. Cl. 248/425

(57) ABSTRACT

A rotary display stand includes: a base; a driving unit mounted to the base; a first magnet unit mounted to the base and driven by the driving unit to rotate about an axis relative to the base; and a support supported on the base and including a second magnet unit that is magnetically driven by the first magnet unit to rotate about the axis relative to the base.

### CROSS-REFERENCE TO RELATED APPLICATION

This application claims priority of Taiwanese application no. 097102855, filed on Jan. 25, 2008.

### BACKGROUND OF THE INVENTION

1. Field of the Invention

The invention relates to a rotary display stand, more particular to a rotary display stand having a display pattern driven magnetically using a pair of magnet units.

2. Description of the Related Art

Conventionally, a rotary display stand for advertisement or exhibition purposes is normally driven by a motor through a set of gears. However, as the volume or weight of an exhibit in the rotary display stand increases, rotation of the exhibit requires more power and the relevant components of the rotary display stand, such as the motor and the gear sets, are required to be larger correspondingly, which requires a larger space for accommodating the rotary display stand and which increases the manufacturing costs considerably.

### SUMMARY OF THE INVENTION

Therefore, an object of the present invention is to provide a rotary display stand that can overcome the aforesaid drawbacks associated with the prior art.

Accordingly, a rotary display stand of the present invention comprises: a base; a driving unit mounted to the base; a first magnet unit mounted to the base and driven by the driving unit to rotate about an axis relative to the base; and a support supported on the base and including a second magnet unit that is magnetically driven by the first magnet unit to rotate about the axis relative to the base.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a rotary display stand according to the present invention;

FIG. 2 is a cross-sectional view of the preferred embodiment; and

FIG. 3 is a plan view to illustrate the arrangement of magnet units of the preferred embodiment.

### DETAILED DESCRIPTION OF THE PREFERRED EMBODIMENT

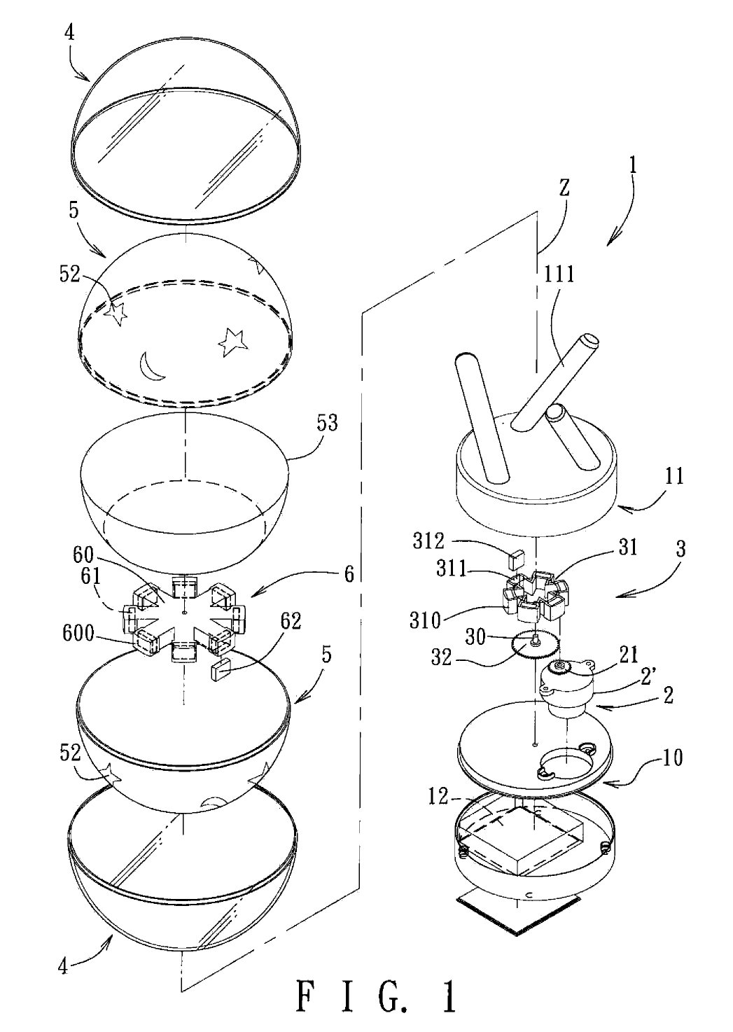

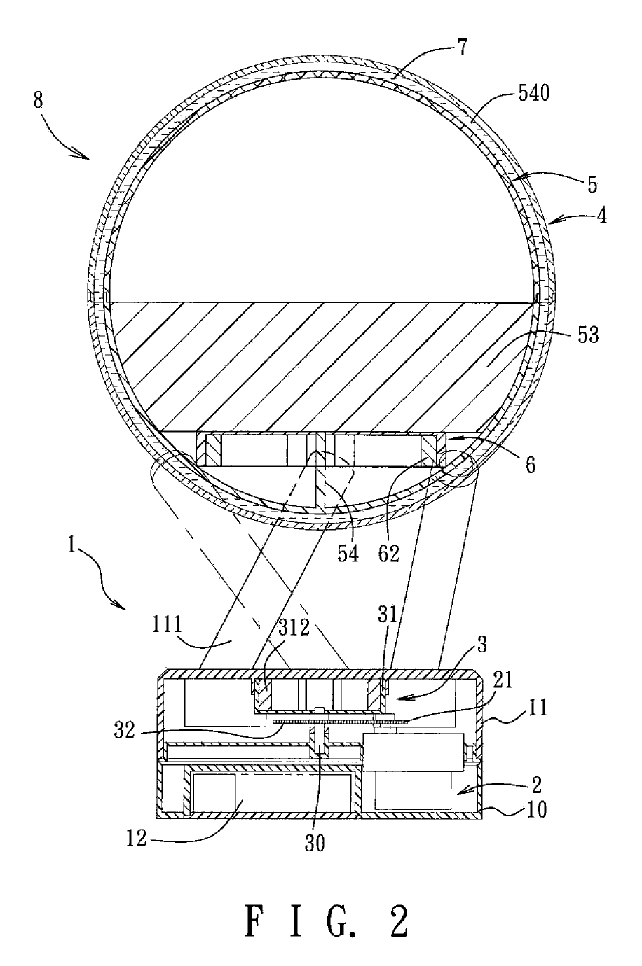

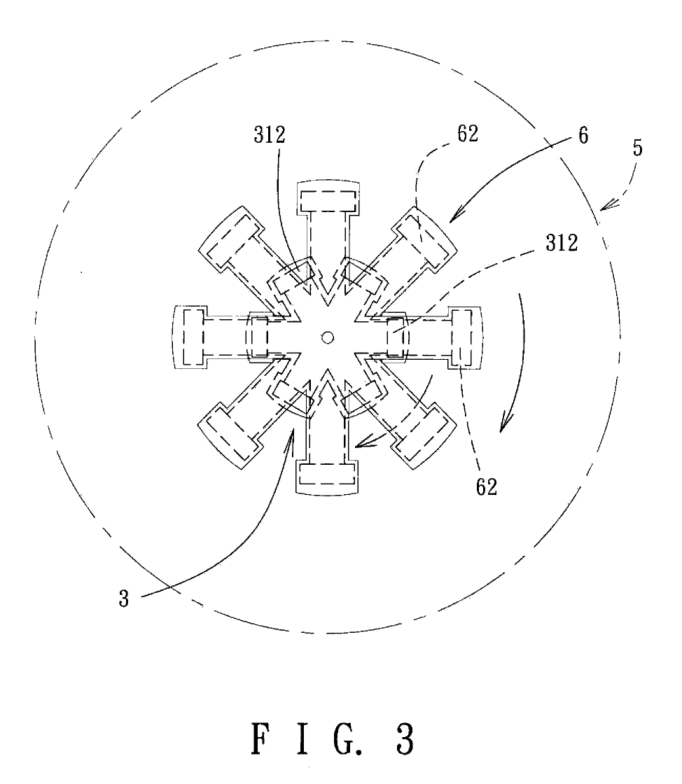

Referring to FIGS. 1 to 3, the preferred embodiment of a rotary display stand according to the present invention is shown to include a base 1, a driving unit 2, a first magnet unit 3, and a support 8. The driving unit 2 and the first magnet unit 3 are mounted to the base 1. The support 8 has a second magnet unit 6. The first magnet unit 3 is driven by the driving unit 2 to rotate about an axis (Z) relative to the base 1. The second magnet unit 6 is magnetically driven by the first magnet unit 3 to rotate about the axis (Z) relative to the base 1. In other words, when the first magnet unit 3 is driven by the driving unit 2 and rotates, the attractive or repulsive force between the first and second magnet units 3, 6 will drive the second magnet unit 6 to rotate accordingly.

In this embodiment, the support 8 further includes a hollow outer spherical body 4 seated on the base 1, and a hollow inner spherical body 5 disposed in and cooperating with the outer spherical body 4 to define a gap 540 therebetween. The outer spherical body 4 and the inner spherical body 5 are concentric. A liquid 7 is filled in the gap 540. The second magnet unit 6 is disposed in and secured to the inner spherical body 5 so as to permit co-rotation of the second magnet unit 6 and the inner spherical body 5 about the axis (Z) relative to the outer spherical body 4 upon rotation of the first magnet unit 3. With the formation of the gap 540 and with the liquid 7 filling the gap 540, the friction between the outer spherical body 4 and the inner spherical body 5 can be ignored. Thus, the inner spherical body S of the support 8 for exhibiting or advertising purposes can be rotated efficiently even when the size or the weight of the support 8 is increased.

In the preferred embodiment, the outer spherical body 4 and the liquid 7 are transparent. The liquid 7 is preferably water or oil. In this embodiment, the inner spherical body 5 is formed with a display pattern 52 and serves as an exhibit. Each of the outer and inner spherical bodies 4, 5 includes two semi-spherical halves that are detachably connected to each other.

The inner spherical body 5 is provided with a shaft 54 disposed therein and extending along the axis (Z). The second magnet unit 6 is securely sleeved on the shaft 54.

Preferably, the support 8 further includes a weight 53 attached to the second magnet unit 6 to stabilize rotation of the inner spherical body 5 relative to the outer spherical body 4. Since the liquid 7 disposed in the gap 540 between the outer spherical body 4 and the inner spherical body 5 can provide buoyancy to the inner spherical body 5, the inner spherical body 5 tends to collide with the outer spherical body 4. By the provision of the weight 53, tendency of the collision of the inner spherical body 5 with the outer spherical body 4 can be alleviated.

The base 1 includes a box 10 having a lid 11 that is provided with a plurality of supporting posts 111 thereon. The lid 11 is preferably provided with at least three supporting posts 111. The driving unit 2 and the first magnet unit 3 are disposed in the box 10. The outer spherical body 4 is detachably seated on the posts 111.

In the preferred embodiment, each of the first and second magnet units 3, 6 includes a rotary body 31, 60 having a plurality of lobes 310, 600 radiating therefrom. Each of the lobes 310 has an upward opening trench 311 for receiving a magnet 312 therein, and each of the lobes 600 has a downward opening trench 61 for receiving a magnet 62 therein.

The driving unit 2 includes a motor 2′ and a gear set of first and second gears 21, 32 connected to the motor 2′ and the first magnet unit 3, respectively. The gear set is driven by the motor 2′. The second gear 32 has a transmission shaft 30 that is coaxially connected to the first magnet unit 3 for rotating the same. As such, the first magnet unit 3 can be driven by the motor 2′ via the gear set.

In the preferred embodiment, the box 10 defines a battery chamber 12 for receiving a battery unit (not shown) and having a switch (not shown) for controlling the motor 2′.

With the inclusion of the first and second magnet units 3, 6 in the rotary display stand of this invention, the aforesaid drawbacks associated with the prior art can be alleviated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A rotary display stand comprising:
a base;
a driving unit mounted to said base;
a first magnet unit mounted to said base and driven by said driving unit to rotate about an axis relative to said base; and
a support supported on said base and including a second magnet unit that is magnetically driven by said first magnet unit to rotate about said axis relative to said base.

2. The rotary display stand of claim 1, wherein said support further includes a hollow outer spherical body seated on said base, a hollow inner spherical body disposed in and cooperating with said outer spherical body to define a gap therebetween, and a liquid filling said gap, said second magnet unit being disposed in and secured to said inner spherical body so as to permit co-rotation of said second magnet unit and said inner spherical body about said axis relative to said outer spherical body upon rotation of said first magnet unit.

3. The rotary display stand of claim 2, wherein said outer spherical body and said liquid are transparent, said inner spherical body being formed with a display pattern.

4. The rotary display stand of claim 2, wherein said inner spherical body is provided with a shaft disposed therein and extending along said axis, said second magnet unit being securely sleeved on said shaft.

5. The rotary display stand of claim 1, wherein said support further includes a weight attached to said second magnet unit.

6. The rotary display stand of claim 1, wherein said base includes a box having a lid that is provided with a plurality of supporting posts thereon, said driving unit and said first magnet unit being disposed in said box, said outer spherical body being detachably seated on said posts.

7. The rotary display stand of claim 1, wherein each of said first and second magnet units includes a rotary body having a plurality of lobes radiating therefrom, each of said lobes being provided with a magnet.

8. The rotary display stand of claim 1, wherein said driving unit includes a motor and a gear set connected to said motor and said first magnet unit.
